(19) United States
(12) Patent Application Publication
(10) Pub. No.: US 2018/0257448 A1
(43) Pub. Date: Sep. 13, 2018

(54) MODULAR AIR LAND VEHICLE

(71) Applicant: Raymond Joseph Schreiner, Mountain View, CA (US)

(72) Inventor: Raymond Joseph Schreiner, Mountain View, CA (US)

(21) Appl. No.: 15/454,031

(22) Filed: Mar. 9, 2017

(51) Int. Cl. B60F 5/02; B64C 37/00; B64C 27/04; B64C 35/00; G05D 1/00

(52) U.S. Cl. CPC B60F 5/02; B64C 37/00; B60Q 1/04; B64C 35/00; G05D 1/0011; B64C 27/04

(57) ABSTRACT

A modular air land vehicle comprising an air vehicle module and a roadworthy land vehicle module, which may interconnect by the air vehicle module landing directly on a stationary or moving land vehicle module as appropriate for the air vehicle lifting design. The air vehicle module has the capability/utility of separating from the land vehicle module and taking off in a flight mode; thereby enabling the air and land modules to be operated separately and independently without the need to take heavy roadworthy structure into flight. This invention provides the combined benefits of air vehicle travel and land vehicle travel allowing the land vehicle systems or structure to be tailored and optimized for land and road travel without unduly increasing the air vehicle weight or aerodynamic drag.

### BACKGROUND OF THE INVENTION

### Field

This invention pertains to methods and apparatuses related to air and land vehicles that can be operated separately or together as a means to provide convenient and flexible transportation for people and/or things. In particular it pertains to air vehicles capable of landing on and physically interfacing with releaseably coupling land vehicles to form a combined land transportation vehicle. The land vehicle (module) includes wheels, tires, suspension, and other components specifically designed for land and road travel and may also include provisions for fuel/energy transfer between air and land modules. The air vehicle module includes the capability/utility of separating therefrom the land vehicle module and taking off in a flight mode enabling the air and land modules the capability/utility to be operated separately and independently.

### State of the Art

The advent of controlled powered flight with the Wright brother's historic flight on Dec. 17, 1903 ushered in an explosion of aircraft development that has led to the current era of effective long-distance mass transportation by air. Ever since man took to the skies, a desire and expectation for a vehicle capable of both air and land travel has existed. This desire is focused on convenient and efficient point-to-point travel and includes a mechanism for pilots to safely land and continue travel in the event of inclement weather. However, achieving wide-spread combined air and land travel in the same vehicle has been constrained by available aircraft designs. Additionally, physical infrastructure of airports and heliports remain inadequate in quantity, location and convenience. For currently available aircraft designs true point-to-point travel via air vehicle is simply impractical for most modern-day travel requirements. To improve the utility of convenient air and land travel, numerous efforts to create an aircraft capable of safe and effective road travel (a.k.a. “flying car” or “roadable aircraft”) have been made.

In 1917, Glenn Curtiss revealed what is widely considered as the first attempt of a roadable aircraft with his Curtiss Autoplane. The Curtiss Autoplane consisted of an automobile-like fuselage with integrated wheels for landing and road travel, three main wings, a pusher-propeller at the rear of the car/fuselage, and a horizontal/vertical tail assembly mounted on a tail boom aft of the pusher propeller. The Curtiss Autoplane was designed to land and disconnect the wings and tail for road travel. The Curtiss Autoplane was also designed to be propelled both on the land and in the air by a propeller mounted on the aft end of the fuselage/car.

In 1918, Felix Longobardi was issued the first patent for a roadable aircraft, U.S. Pat. No. 1,286,679, but a working prototype was never built.

In grand arrival fashion in 1936, the Autogiro Company of America flew their design of a roadable aircraft, known as the AC-35, into the National Mall in Washington D.C. and then drove the vehicle to the Bureau of Air Commerce. The AC-35 tail-wheel was modified to allow clutched engagement to the engine and the rotors were folded back and secured for the road travel.

In 1937, Waldo Waterman revealed a roadable aircraft design deemed Arrowbile (a.k.a “Aerobile”) that included a three-wheeled fuselage, a pusher propeller, and a foldable wing spanning 38-feet that was intended to remain attached during road travel. Like the Curtiss Autoplane, the Waterman Aerobile required the use of the propeller for land propulsion since there were no provisions for mechanical drive to the wheel system. The pursuit to produce the Waterman Aerobile was eventually abandoned due to an overly complex tradeoff in weight and propulsion.

In 1946, Robert Fulton Jr. revealed his design deemed Airphibian. The Airphibian consisted of an aluminum bodied automobile with four integral wheels and independent suspension, and a detachable assembly which included a high-mounted fabric main-wing and tail section. The four Airphibian wheels were aircraft sized and not optimized for road travel. One of the prototypes of the Airphibian was the first flying car to be certified by the US Civil Aeronautics Administration (CAA) (predecessor to the US FAA).

Also in 1946, Consolidated Vultee Aircraft (later Convair) flew a prototype roadable aircraft known as Model 116. The model 116 and the later model 118 both were also known as the ConVairCar. The ConVairCar designs included an automobile body with four integrated wheels, suspension, automobile engine/drive-train, and a detachable monoplane assembly that mounted on the top of the vehicle. The Convair monoplane assembly included a second engine and tractor propeller that operated independent of the automobile propulsion system.

Inspired by Robert Fulton's Airphibian, Moulton Taylor's Aerocar first flew in 1949. Taylor's design included foldable wings that could be pulled behind the automobile for land travel, and a single engine that drove both a pusher propeller and the front wheels of the permanently integrated automobile. The Aerocar received CAA certification in 1956, but only six aircraft were produced. Another historic example, the Wagner Aerocar, was a German design by Alfred Vogt for a four-place automobile with counter-rotating helicopter rotors. A prototype of the Wagner Aerocar flew in 1965 but was never produced.

In 2010, the FAA issued a Light Sport Aviation (LSA) certificate for the Maverick Sport flying car built by Beyond Roads LLC, The Maverick Sport utilizes a lightweight tandem 2-seat car, essentially a canvas covered dune buggy, with a pusher-propeller. The Maverick Sport can be lifted by a parachute system in the same manner as a powered parachute by using the pusher propeller for forward thrust. For road travel, the propeller of the Maverick Sport is disengaged and the engine engages a drive train system to the wheels. Although a novel design, the aircraft and vehicle performance are limited. While Beyond Roads LLC currently'maintains the rights to build and distribute the Maverick flying car, the project is currently on hold according to the company.

In 2011, legendary aircraft designer Burt Rutan and his company Scaled Composites debuted a roadable aircraft design called Bi-pod. Bi-pod is a two-seat, four-wheeled aircraft with detachable wings and two fuselages (or pods) linked by two smaller lifting surfaces. Bi-Pod conducted only limited flight testing and Scaled Composites maintains the Bi-Pod prototype with hopes of maturing the design.

Terrafugia Inc. created a “Roadable Aircraft with Folding Wings and Integrated Bumpers and Lighting” (U.S. Pat. No. 7,938,358 B2, May 2011), also known as the “Transition.” Two Terrafugia Transition prototypes have successfully flown and driven roads and have achieved a remarkable engineering balanced for roadable aircraft. A third generation prototype of the Terrafugia Transition is currently being pursued for the US Light Sport Aircraft (LSA) category. While the Terrafugia Transition is a notable engineering accomplishment, the design will suffer from the requirement to use a runway or other long prepared surface for takeoff and landing. Additionally multiple exemptions for Federal Motor Vehicle Safety Standards (FMVSS) have been sought for the design, and historically airplane performance suffers due to weight of roadworthy systems and wing folding mechanisms.

While it is clear that several roadable aircraft have been attempted with novel engineering designs explored, no widespread practical commercial success has yet been achieved and additional design options are needed. Previous designs entail incorporating complicated and/or heavy structure and systems designed for road travel into self-contained road/air vehicles; thereby significantly reducing the flight performance or sacrificing road safety to salvage flight performance. Stringent federal motor vehicle safety standards (FMVSS) and general public expectations for vehicle safety make the engineering of viable roadable aircraft particularly challenging. Propulsion and structural complexity (or oversimplification), air vehicle weight, motor vehicle safety standards, human interface, and aerodynamic performance are factors that have proven collectively an enormous engineering obstacle for the design of a self-contained roadable aircraft. Additionally, for takeoff and landing, previous fixed-wing roadable aircraft designs have suffered from the requirement to use a runway or other suitably prepared surfaces, which are limited in quantity, location and convenience.

Previous inventions have not included options for detaching an air vehicle (module) optimized for flight performance from a land vehicle (module) designed for roadworthy safety and performance standards. The Modular Air Land Vehicle discussed in this disclosure provides such an invention. This invention provides the utility of a modular transportation vehicle that leaves on the ground the bulk of weighty systems needed and purposefully tailored for road travel while facilitating detachment and separate operation of a lighter-weight air vehicle tailored for flight. Additionally, while several uses of simple launch and landing carts for aircraft exist, this invention documents a new utility combination land/air vehicle for purposely-built roadworthy land vehicles (modules) that can be directly landed on and purposefully used in conjunction with the air vehicle (module) for continued road travel. The invention described here outlines the combination of a detachable air vehicle (module) from a land vehicle (module) that will provide improved utility for air and land transportation of people and/or things.

### SUMMARY OF THE INVENTION

The invention, a Modular Air Land Vehicle, combines the utility of an air vehicle module with the utility of a land vehicle module in which the air vehicle and land vehicle modules may be operated independently or combined as a roadworthy vehicle. This invention provides the combined benefits of air vehicle travel and land vehicle travel allowing the land vehicle systems or structure to be tailored and optimized for land and road travel without unduly increasing the air vehicle weight or aerodynamic drag. It comprises:

a. an air vehicle module having

i. a frame and fuselage with

ii. a passenger and/or cargo compartment with ingress and egress structure,

iii. an interface mechanism structured and adapted to securely join with and releasably detach from the land vehicle module

iv. a lift and control system operably associated with

v. at least one engine or motor driving a propeller, rotor, or jet thruster structured to provide lift and/or forward thrust to the air vehicle module for flight,

vi. a fuel or energy source to power the engine or motor system as appropriate,

vii. supporting wings and other aerodynamic stability and control surfaces mounted to the frame and fuselage providing lift;

said air vehicle module frame, fuselage and components structured aerodynamically for flight, and

b. a land vehicle module having

i. a land vehicle frame operably associated with

ii. supporting wheels, tires, brakes, suspension, and drive-train structured to engage a drive surface;

iii. an interface mechanism structured and adapted to securely join with and releasably detach the land vehicle from the air vehicle module

said land vehicle, which, when connected thereto, may be powered by the integral land vehicle module drive-train system or the air vehicle module's energy storage or propulsion system.

In addition to wheels, tires, brakes, suspension and drive-train appropriate for the intended driving surface, the land vehicle module usually includes headlights, tail lights, blinkers, bumpers, and other related safety and/or comfort related equipment for road driving. In a preferred embodiment, the land vehicle module will include an integral engine/drive-motor and drive-train to power the wheels of the modular air land vehicle in driving modes. Additionally in a preferred embodiment, the human interface for manual control or automated control to human navigation commands for the combined vehicle on land will be conducted from the air vehicle module seating compartment. In other embodiments, the automated controls are remotely operated and can be located within or without the seating compartment.

Embodiments of this invention usually include the capability for the air vehicle module to land and connect with the land vehicle module while the land vehicle module is moving along the ground or stationary if the lift and control system allow vertical landing. The air vehicle landing and connection of the two vehicles can also be done with the land vehicle module stationary. Alternatively the air and land modules may become joined or connected while both elements on the land through ground based docking mechanisms.

Additional embodiments of this invention include the following options:

a. the land vehicle may utilize the air vehicle propulsion system for land propulsion.

b. the land vehicle may include a rolling tracked system for land movement.

In still another embodiment, a single or a series of land vehicle modules may have frames or bumpers structured to be coupled and pulled by a locomotive along a track, or a truck pulled along a road; providing the utility of a series of land vehicle modules suitable for landing and transporting a single or plurality of air vehicle modules,

The lift and control system of the air vehicle module may be of fixed-wing design, rotary-wing design, or compound aircraft design providing aerodynamic forces to facilitate movement through the air. The lift generating surfaces will normally include an airfoil shape with a streamlined cross-section designed for lift producing.

The land vehicle module may be structured as a land vehicle, a water surface vehicle, or a snow surface vehicle. The land vehicle module includes structure, suspension, power train, and energy/fuel storage to augment the combined air vehicle and land vehicle modules during surface transportation. The land vehicle module may be moving or stationary when landing the air vehicle module.

The air vehicle module typically includes cockpit controls for controlling the air vehicle module and may include automated or remote navigation systems for remotely controlling the air vehicle module.

### DESCRIPTION OF THE DRAWINGS

FIG. 1 is a side view of the Modular Air Land Vehicle with a rotorcraft air vehicle module detached from the land vehicle module,

FIG. 2 is a top view of the air vehicle module of FIG. 1.

FIG. 3 is a perspective view of the land vehicle module of FIG. 1

FIG. 4 is a view of a motorized land vehicle module.

FIG. 5 is a top view of the motorized land vehicle module of FIG. 4

FIG. 6A is a cross sectional view of an open fastener.

FIG. 6B is a cross sectional view of the fastener of FIG. 6A closed.

FIG. 7 is a blown up cross sectional view of the corresponding releaseable interface securing system of FIG. 1

FIG. 8 is a view of an auto gyro air vehicle module.

FIG. 9 is a view of a compound aircraft air vehicle module.

FIG. 10 is a view of a tilt-roto aircraft air vehicle module.

FIG. 11 is a view of a fixed wind aircraft air vehicle module.

FIG. 12 is a view of a multiple rotor aircraft air vehicle module.

FIG. 13 is a magnetic positioning connector affixed to an aircraft air vehicle module approaching a corresponding magnetic positioning connector on a land vehicle module.

FIG. 13a illustrates the magnetic positioning connectors of FIG. 13 near complete connection.

FIG. 14 illustrates a mechanical positioning connector on the aircraft air vehicle module approaching a corresponding mechanical positioning connector on a land vehicle module.

FIG. 14a illustrate the mechanical positioning connectors of FIG. 14 near complete connection.

### DETAILED DESCRIPTION OF THE INVENTION

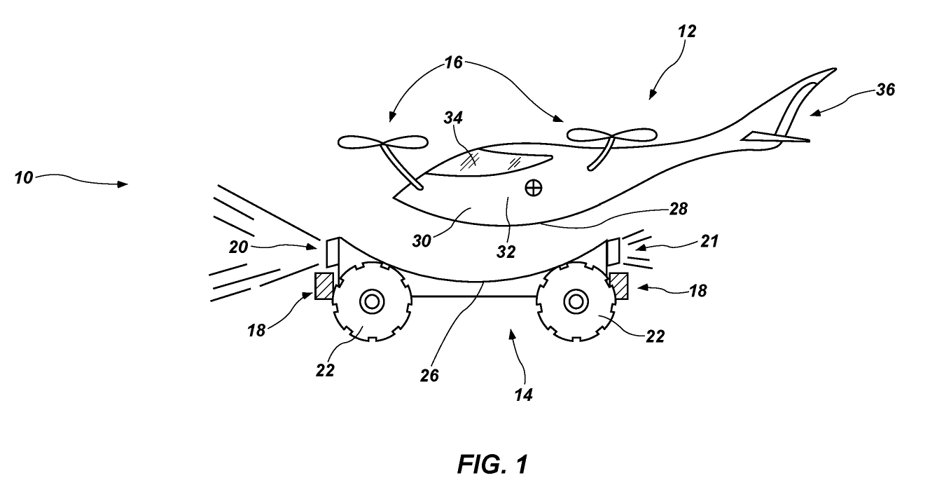

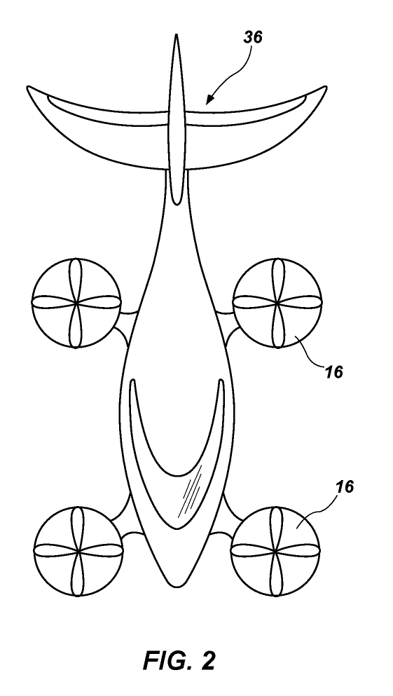

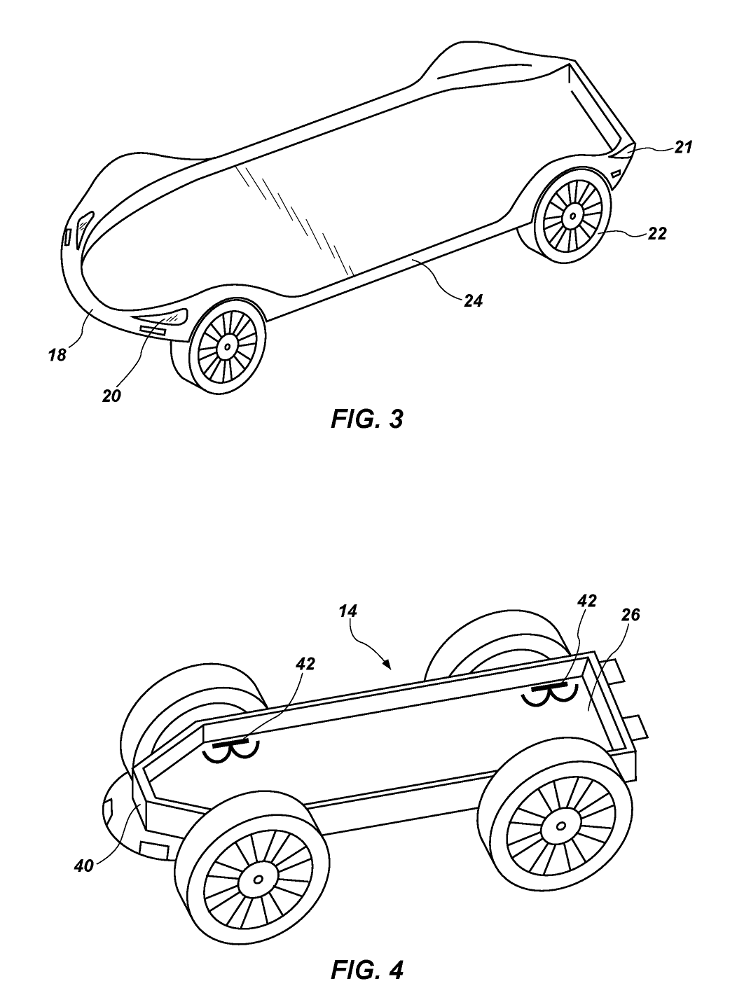

FIGS. 1 to 3 illustrate an embodiment of the modular air land vehicle 10 with the following components; air vehicle module 12, and road vehicle module 14.

In one embodiment of this invention 10, a rotorcraft or multi-rotor aircraft module 12 lands on and docks with land vehicle modulel4 to become a roadable aircraft system. In this embodiment, this invention and the nature of the air vehicle module 12 lift and control system 16 provide the ability to land and dock to the land vehicle module14 with or without any forward airspeed. Additionally in this embodiment, there is no need to take the land vehicle module 14 or large fixed wing structure or complex folding mechanisms onto roads or into the air for relatively short air trips.

As shown in FIG. 1, the land vehicle module typically includes a bumper 18, headlights 20, tail lights and blinkers 21, and wheels and suspension 22 mounted to a frame 24 with a receiving and securing interface 26. While the land vehicle shown in FIG. 1 diagrams an embodiment with four wheels, a land vehicle of any wheeled and/or tracked configuration may incorporated on the land vehicle module of this invention.

The air vehicle module 12 has vertical take-off and landing capability with an air vehicle interface 28 adapted to land on the receiving interface 26 of the land vehicle module 14. The air vehicle module 12 has a fuselage 30 defining a passenger cabin 32 with passenger ingress and egress access. A windshield 34 is included for pilot visibility when not operated remotely or autonomously. The air vehicle module 12 usually includes a tail section with stabilizers 36.

FIG. 4 is a view of a motorized land vehicle module 14 powered by an electric or combustion motor 40. The releaseable interface 26 of the land vehicle module 14 has grooves with a latch 42 structured to releaseably secure to bars 44 of the corresponding securing system of the air vehicle frame 14 as shown in FIGS. 6A and 6B. The latch 42 is hinged open as shown in FIG. 6A. When contacted by the bar 44 of the air vehicle frame 14, it snaps closed to secure about the bar 44, as shown in FIG. 6B to secure the air vehicle 12 to the land vehicle module 14 in a driving mode. To launch the air vehicle module 12, the latch 42 is opened releasing the bar 44 of the air vehicle frame 12.

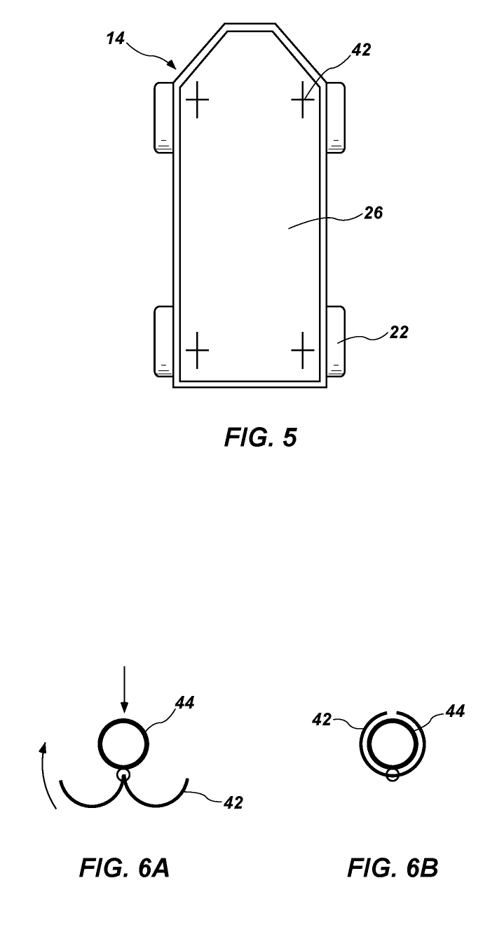

Although FIGS. 4-6B illustrate a mechanical latching system, other electric latches, magnetic contacts, and other fastening devices may be used to releaseably secure the air vehicle module 12 to the to the land vehicle module 14.

FIG. 7 is a blown up cross sectional view of the corresponding releaseable interface securing system of FIG. 1. The corresponding contact surfaces 26, 28 of the air vehicle module 12, and the land vehicle module 14 have corresponding fitted surfaces with slots and grooves to accommodate the latches 42, and bars 44 discussed above. These corresponding contact surfaces 26, 26 are preferably universally shaped to accommodate a wide variety of air vehicle modules 12 as shown in FIGS. 8-12. Also note that the wheels 22 shown are adapted to run along railroad tracks with the bumpers 18 including releaseable couplings 19 to interconnect a plurality of land vehicle modules 14 for pulling by and engine, or truck. The selection of the type of wheels 22 is therefore dependent upon whether the land vehicle modules 14 run along highways or railroad tracks.

FIG. 8 is a view of an auto gyro air vehicle module.

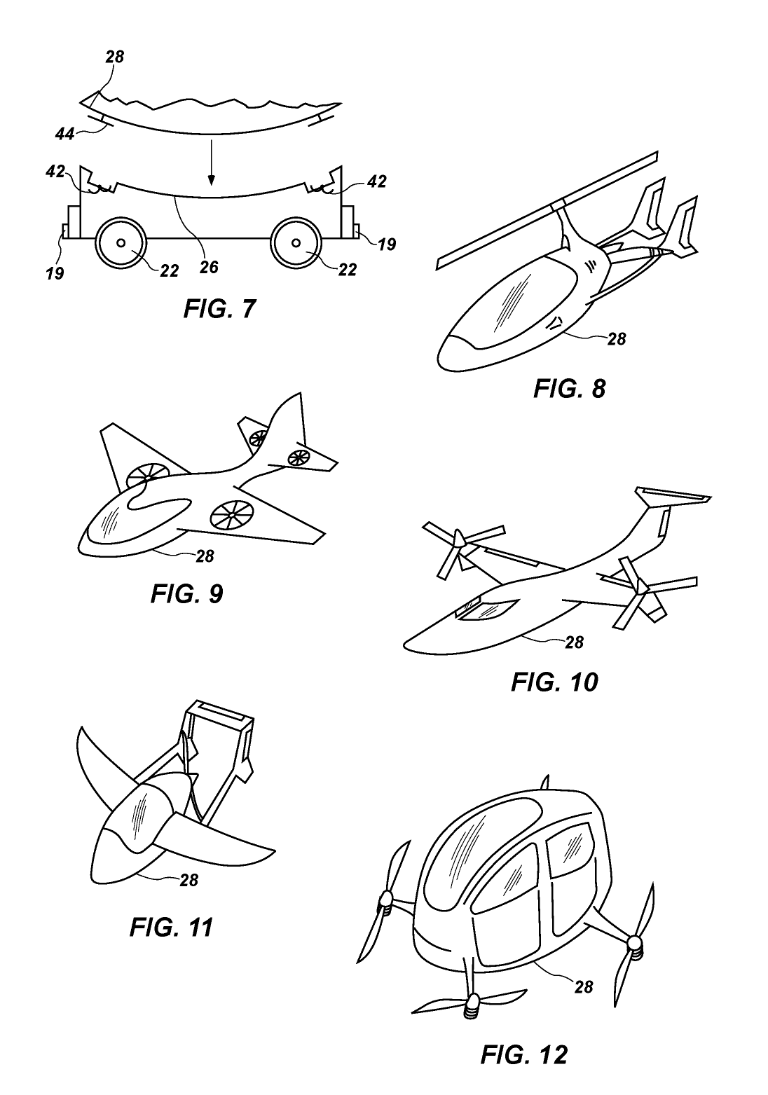

FIG. 9 is a view of a compound aircraft air vehicle module capable of landing in fixed wing or rotary-wing modes onto the land vehicle module 14 with appropriate airspeed for the mode. FIG. 10 is a view of a tilt-roto aircraft air vehicle module.

FIG. 11 is a view of a fixed wind aircraft air vehicle module. In this embodiment, the wings 22 of the air-vehicle must be detached or folded for land transportation on roads.

FIG. 12 is a view of a multiple rotor aircraft air vehicle module.

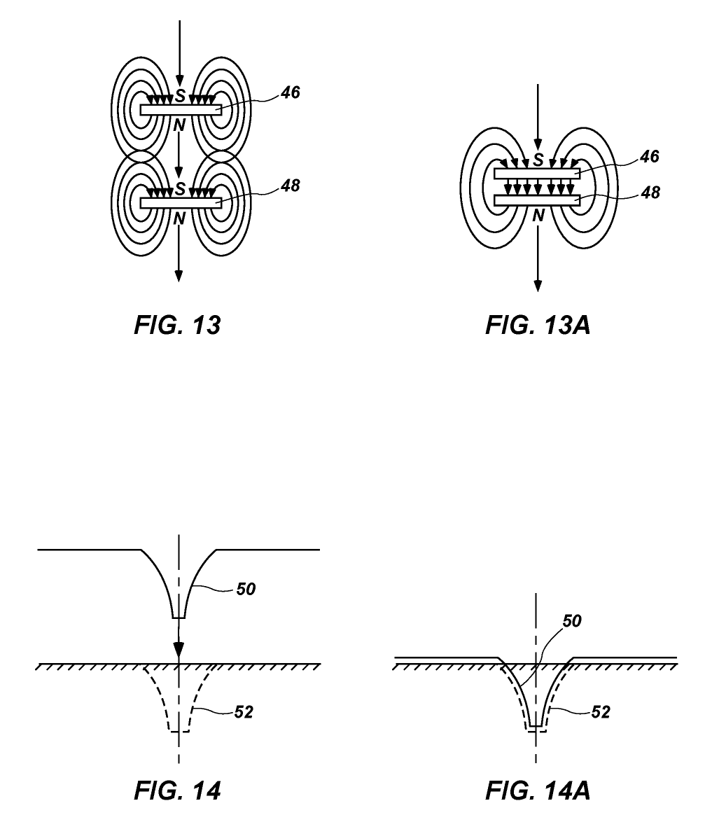

FIG. 13 is a magnetic positioning connector 46 affixed to an aircraft air vehicle module 12 approaching a corresponding magnetic positioning connector 48 on a land vehicle module 14.

FIG. 13a illustrates the magnetic positioning connectors 46, 48 of FIG. 13 near complete connection.

FIG. 14 illustrates a male mechanical positioning connector 50 on the aircraft air vehicle module 12 approaching a corresponding mechanical positioning female connector 52 on a land vehicle module 14.

FIG. 14a illustrate the mechanical positioning connectors 50, 52 of FIG. 14 near complete connection.

These embodiments of various air vehicle modules 12 land on and dock with a roadable land vehicle modules 14 to become a roadable aircraft system. In these embodiments, the invention and the nature of the air vehicle modules 12 lift and control system 16 provide the ability to land on and dock to the land vehicle module 14 with forward airspeed as the land vehicle moves under its own drive-train 18 and control system 20.

For the utility of moving people from point-to-point, the previously mentioned embodiments are well-suited for land vehicles modules 14 with or without driverless car technology 24 since the land vehicle module 14 may continue on a subsequent land journey once the air vehicle module 12 has departed. A different land vehicle module 14 could be used near the air vehicles destination to allow an option for completing the final leg of the journey as a combined land vehicle. This invention is therefore also well-suited for crowd-sharing of land vehicle modules 14 and point-to-point transportation for air vehicle module 12 with people and/or cargo.

This invention thus provides the utility to detach an air vehicle from a land vehicle and operate the air and land vehicle modules 12, 14 separately and independently. The modules 12, 14 may be operated manually or automatically for subsequent dockings with other modules at various different locations. Additionally, this invention provides for utility of the land vehicle module 14 to incorporate roadworthy structure, lighting, wheels, suspension, fuel/energy storage and transfer systems, and other comfort/safety systems optimized for land vehicles without negatively impacting the air vehicle module 12 performance.

The power source of the land vehicle module 14 may be used to charge other electric vehicles when not associated with an air vehicle module 12. Thus when driving along a highway and uncoupled to an air vehicle module 12, the land vehicle module 14 may be used as a power source to charge other conventional electric vehicles low on power. The land vehicle module 14 thus acts as a charging station when not used to power an air vehicle module 12.

The above description and specification should not be construed as limiting the scope of the invention but as merely providing a descriptive language and reference to illustrations for presently preferred embodiments of this invention.

The invention as described above may be embodied in other specific forms without departing from the primary intended utility, functional operation, or other essential characteristics as broadly described herein and claimed hereinafter. The language used in the invention description and claim specification was selected principally for readability and instructional purposes, and may not have been specifically selected to comprehensively delineate or holistically circumscribe the inventive subject matter. Accordingly, the above descriptive disclosure and claims below are therefore intended to be generally illustrative of the overall utility of this invention, but not limiting in depth or breadth of the invention scope. The described embodiments are to be considered in all respects only as illustrative and not restrictive. The range and scope of this invention is, therefore, indicated by the appended claims, as well as the foregoing description.

I claim:

1. A modular air land vehicle that may be separated into air and land vehicles modules which may be operated together or separately comprising:
a. an air vehicle module having
i. a frame defining a fuselage with a passenger compartment for ingress and egress,
ii. an optional cargo compartment or accommodation for carrying cargo internal or external to the fuselage,
iii. a lift and control system mounted to the frame,
iv. at least one engine driving propellers, rotors and/or lift system mounted on the frame operably associated with the lift and control system to provide lift and forward thrust to the air vehicle module for flight, and
v. a power/energy source associated with the engine and/or motors to drive the propellers and/or lift system;
said frame and fuselage structured aerodynamically for flight with a bottom interface adapted to releaseably secure to a land vehicle frame, and
b. a land vehicle module having
i. a land vehicle frame, and
ii. wheels and suspension mounted to the land vehicle frame structured to engage and move along a drive surface;
said land vehicle frame structured to removeably interface with the air vehicle frame bottom interface and secure thereto in a drive mode to be powered along a road surface by the air vehicle module engine and propellers and/or its own drive engine; or in a standby mode where the land vehicle may be moving or stationary ready to removeably couple with an air vehicle module frame.

2. A modular air land vehicle according to claim 1, wherein the air vehicle module has supporting wings having an airfoil shape with a streamlined cross-sectional shape producing lift and thrust producing components such as propellers, rotors, or jet thrusters to produce aerodynamic forces facilitating controlled powered flight.

3. A modular land vehicle according to claim 2, wherein the air vehicle module has aerodynamic control surfaces such as an elevator or rudder, lift/thrust producing components such as propellers, rotors, or jet thrusters, mounted on the frame and fuselage to produce aerodynamic forces facilitating controlled powered flight.

4. A modular air land vehicle according to claim 1, wherein the land vehicle module frame includes: headlights, tail lights, blinkers, bumpers, and other related safety equipment required for public road driving.

5. A modular air land vehicle according to claim 1, including an engine and drive-train or electric motor system associated with the land vehicle module wheels to power the land vehicle module in a driving mode.

6. A modular air land vehicle according to claim 1, wherein the land vehicle module bumpers and frame components are structured to be coupled and pulled when connected with a plurality of correspondingly structured land vehicle modules by a locomotive along a track, or a truck along a road; providing a series of land vehicle modules for landing and transporting a corresponding plurality of air vehicle modules.

7. A modular air land vehicle according to claim 1, wherein the air vehicle module may be of fixed-wing, rotary wing design, or compound aircraft design with appropriate structure to physically interface with the land vehicle module.

8. A modular air land vehicle according to claim 1, wherein the land vehicle module is structured as a land vehicle.

9. A modular land vehicle according to claim 1, wherein the land vehicle module is structured as a water surface vehicle.

10. A modular land vehicle according to claim 1, wherein the land vehicle module is structured as a snow surface vehicle.

11. A modular air land vehicle according to claim 1, wherein the land vehicle module includes structure, suspension, power train, and optional energy/fuel storage to augment the combined air vehicle and land vehicle modules during surface transportation.

12. A modular air land vehicle according to claim 1, including air vehicle module cockpit controls for controlling the air and/or land vehicle modules.

13. A modular air land vehicle according to claim 1, including automated or remote navigation systems for controlling the air or land vehicle module.

14. A modular air land vehicle according to claim 1, wherein the land vehicle module may be moving, or stationary when connection occurs.

15. A modular air land vehicle according to claim 1, wherein the power source of the land vehicle module may be used to charge other electric vehicles when not associated with an air vehicle module.
